(19) United States
(12) Patent Application Publication
(10) Pub. No.: US 2024/0212917 A1
(43) Pub. Date: Jun. 27, 2024

(54) COIL COMPONENT

(71) Applicant: SAMSUNG ELECTRO-MECHANICS CO., LTD., Suwon-si (KR)

(72) Inventor: Boum Seock KIM, Suwon-si (KR)

(73) Assignee: SAMSUNG ELECTRO-MECHANICS CO., LTD., Suwon-si (KR)

(21) Appl. No.: 18/516,080

(22) Filed: Nov. 21, 2023

(30) Foreign Application Priority Data
Dec. 23, 2022 (KR) 10-2022-0183378

(51) Int. Cl. H01F 27/28; H01F 27/32

(52) U.S. Cl. CPC H01F 27/2823; H01F 27/324

(57) ABSTRACT

A coil component includes a support member, a coil unit including at least one of first and second coil patterns disposed on one surface and the other surface of the support member and respectively including a plurality of turns, and a body in which the support member and the coil unit are embedded, wherein at least one of an innermost turn and an outermost turn of the plurality of turns has a protrusion that protrudes in a direction away from the innermost turn and the outermost turn.

### CROSS-REFERENCE TO RELATED APPLICATION(S)

This application claims benefit of priority to Korean Patent Application No. 10-2022-0183378 filed on Dec. 23, 2022 in the Korean Intellectual Property Office, the disclosure of which is incorporated herein by reference in its entirety.

### TECHNICAL FIELD

The present disclosure relates to a coil component.

An inductor, a type of coil component, is a typical passive electronic component used in electronic devices along with resistors and capacitors.

In the case of a thin film coil component, a type of coil component, a coil pattern is formed on a support member through a thin film process, such as a plating process, and one or more magnetic composite sheets are laminated on the support member on which the coil pattern is formed to form a body, and an external electrode is formed on the body.

Inductance of the coil pattern may increase as the total number of turns of the coil pattern increases, and the total number of turns of the coil pattern in unit area may increase as the width of the coil pattern decreases.

Energy loss in the coil pattern may decrease as an equivalent series resistance of the coil pattern decreases, and the equivalent series resistance of the coil pattern in unit area may decrease as a thickness of the coil pattern increases.

Therefore, it may be important to increase an aspect ratio (A/R), which is a thickness/width ratio of the coil pattern.

### SUMMARY

An aspect of the present disclosure is to provide a coil component having an increased aspect ratio (A/R), which is a thickness/width ratio of a coil pattern, efficiently increased inductance to be advantageous to greater thickness, and/or efficiently decreased energy loss.

According to an aspect of the present disclosure, a coil component includes a support member, a coil unit including at least one of first and second coil patterns disposed on one surface and the other surface of the support member and respectively including a plurality of turns, and a body in which the support member and the coil unit are embedded, wherein at least one of an innermost turn and an outermost turn of the plurality of turns has a protrusion that protrudes in a direction toward a center of the body and toward a side surface of the body, respectively.

According to another aspect of the present disclosure, a coil component includes a support member, a coil unit including at least one of first and second coil patterns respectively disposed on one surface and the other surface of the support member, and a body in which the support member and the coil unit are embedded, wherein at least one of the first and second coil patterns includes a second conductive layer and a first conductive layer contacting and disposed between the second conductive layer and the support member, the second conductive layer has a portion including a protrusion protruding so that a width of the portion of the second conductive layer is wider than a width of one surface of the second conductive layer facing the first conductive layer, and a shortest distance from the one surface of the second conductive layer facing the first conductive layer to the protrusion is greater than a thickness of the protrusion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an exemplary embodiment in the present disclosure;

FIG. 2 is a cross-sectional view illustrating a cross-section taken along line I-I′ in FIG. 1;

FIG. 3 is a cross-sectional view illustrating a cross-section taken along line II-II′ in FIG. 1;

FIG. 4 is an enlarged view of ‘A’ in FIG. 2;

FIG. 5 is a cross-sectional view illustrating a process of forming a protrusion; and

FIG. 6 is a cross-sectional view illustrating a coil component according to an exemplary embodiment in the present disclosure.

### DETAILED DESCRIPTION

The terms used in the present specification are merely used to describe particular exemplary embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but it should be used as a concept that encompasses even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawings, an L direction may be defined as a first direction or length direction, a W direction may be defined as a second direction or width direction, and a T direction may be defined as a third direction or thickness direction.

Hereinafter, a coil component according to an exemplary embodiment in the present disclosure will be described in detail with reference to the accompanying drawings, and in the description with reference to the accompanying drawings, the same or corresponding components are assigned the same reference numerals and overlapping descriptions thereof will be omitted.

Various types of electronic components are used in electronic devices, and various types of coil components may be appropriately used between these electronic components for the purpose of removing noise.

That is, in electronic devices, coil components may be used as power inductors, high-frequency (HF) inductors, general beads, GHz beads, common mode filters, etc.

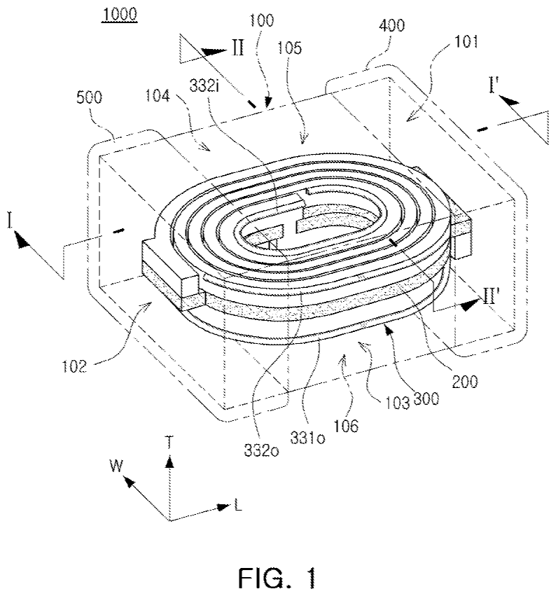

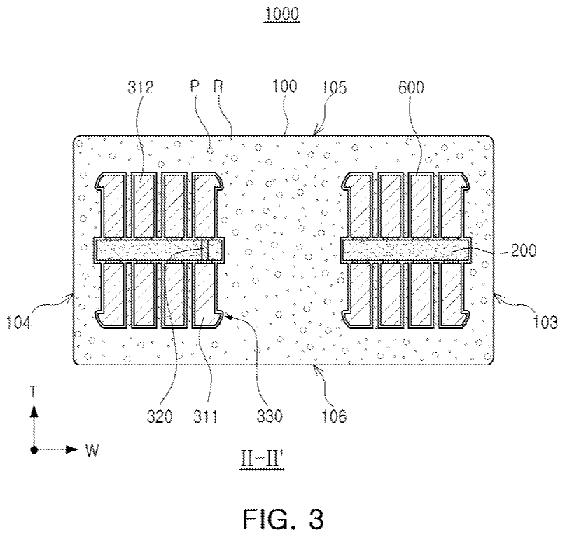

Referring to FIGS. 1 to 3, a coil component 1000 according to an exemplary embodiment in the present disclosure may include a body 100, a support member 200, and a coil unit 300, and may further include external electrodes 400 and 500 and at least one of the insulating film 600.

The body 100 may form the overall appearance of the coil component 1000 according to the present exemplary embodiment, and the support member 200 and the coil unit 300 may be embedded therein. The body 100 may have a shape of a hexahedron as a whole.

Referring to FIGS. 1 to 3, the body 100 includes a first surface 101 and a second surface 102 facing each other in the length direction L, a third surface 103 and a fourth surface 104 facing each other in the width direction W, and a fifth surface 105 and a sixth surface 106 facing each other in the thickness direction T. Each of the first to fourth surfaces 101, 102, 103, and 104 of the body 100 corresponds to a wall surface of the body connecting the fifth surface 105 and the sixth surface 106 of the body 100. Hereinafter, both end surfaces of the body 100 may refer to the first surface 101 and the second surface 102 of the body 100, both side surfaces of the body 100 may refer to the third surface 103 and the fourth surface 104 of the body 100, and one surface of the body may refer to the sixth surface 106, and the other surface of the body 100 may refer to the fifth surface 105. In addition, in the following, upper and lower surfaces of the body 100 may refer to the fifth surface 105 and the sixth surface 106 of the body 100, which are determined based on the directions of FIGS. 1 to 3, respectively.

For example, the body 100 may be formed so that the coil component 1000 according to the present exemplary embodiment, on which external electrodes 400 and 500 to be described below are formed, has a length of 1.035 mm, a width of 0.76 mm, and a thickness of 0.615 mm, but is not limited thereto. To this end, the body 100 may be formed to have a length of 0.975 mm, a width of 0.705 mm to 0.72 mm, and a thickness of 0.58 mm, but is not limited thereto.

The body 100 may include magnetic powder particles P and an insulating resin R. Specifically, the body 100 may be formed by laminating one or more magnetic composite sheets including the insulating resin R and the magnetic powder particles P dispersed in the insulating resin R and then curing the magnetic composite sheets. However, the body 100 may have a structure other than the structure in which the magnetic powder particles P are dispersed in the insulating resin R. For example, the body 100 may be formed of a magnetic material, such as ferrite.

The magnetic powder particles P may be, for example, ferrite or magnetic metal powder particles.

The ferrite powder particles may be at least one of, for example, Mg—Zn-based, Mn—Zn-based, Mn—Mg-based, Cu—Zn-based, Mg—Mn—Sr-based, Ni—Zn-based spinel ferrite, Ba—Zn-based, Ba—Mg-based, Ba—Ni-based, Ba—Co-based, and Ba—Ni—Co-based hexagonal ferrites, garnet-type ferrites, such as Y-based ferrites, and Li-based ferrites.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal powder particles may be amorphous or crystalline. For example, the magnetic metal be powder particles may Fe—Si—B—Cr-based amorphous alloy powder particles, but are not limited thereto.

Each of the ferrite and magnetic metal powder particles may have an average diameter of about 0.1 μm to about 30 μm, but is not limited thereto.

The body 100 may include two or more types of magnetic powder particles P dispersed in the insulating resin R. Here, the different types of magnetic powder particles P means that the magnetic powder particles P dispersed in the insulating resin R are distinguished from each other by one of diameter, composition, crystallinity, and shape. For example, the body 100 may include two or more magnetic powder particles P having different diameters.

The insulating resin R may include epoxy, polyimide, liquid crystal polymer, etc. alone or in combination, but is not limited thereto.

The body 100 includes a core 110 penetrating through the support member 200 and the coil unit 300 to be described below. The core 110 may be formed by filling a through-hole of the coil unit 300 with at least a portion of the magnetic composite sheet in the process of laminating and curing the magnetic composite sheet, but is not limited thereto.

The support member 200 is embedded in the body 100. The support member 200 supports the coil unit 300 to be described below.

The support member 200 may be formed of an insulating material including a thermosetting insulating resin, such as an epoxy resin, a thermoplastic insulating resin, such as polyimide, or a photosensitive insulating resin, or an insulating material impregnated with a reinforcing material, such as glass fiber or inorganic filler in such an insulating resin. For example, the support member 200 may be formed of an insulating material, such as copper clad laminate (CCL), prepreg, Ajinomoto build-up film (ABF), FR-4, bismaleimide triazine (BT) film, photo imageable dielectric (PID) film, but is not limited thereto.

As inorganic fillers, at least one selected from the group consisting of silica (SiO₂), alumina (Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide superior rigidity. When the support member 200 is formed of an insulating material that does not contain glass fibers, the support member 200 is advantageous in reducing the overall thickness of the coil unit 300. When the support member 200 may be formed of an insulating material including a photosensitive insulating resin, the number of processes for forming the coil unit 300 may be reduced, which is advantageous in reducing production costs, and it is possible to form fine vias. The thickness of the support member 200 may be greater than 20 μm and less than 40 μm, more preferably, greater than or equal to 25 μm and less than 35 μm, but is not limited thereto.

The coil unit 300 includes planar spiral first and second coil patterns 311 and 312 disposed on the support member 200 and is embedded in the body 100 to manifest characteristics of the coil component. For example, when the coil component 1000 of the present exemplary embodiment is used as a power inductor, the coil unit 300 may maintain an output voltage by storing an electric field as a magnetic field, thereby stabilizing power of an electronic device.

The coil unit 300 includes first and second coil patterns 311 and 312 and a via 320. Specifically, the first coil pattern 311 is disposed on a lower surface of the support member 200 facing the sixth surface 106 of the body 100 based on the directions of FIGS. 1, 2 and 3, and the second coil pattern 312 is disposed on an upper surface of the support member 200. The via 320 passes through the support member 200 to be in contact with and connected to the first coil pattern 311 and the second coil pattern 312. Accordingly, the coil unit 300 may function as a single coil in which one or more turns are formed around the core 110 as a whole.

The via 320 may include at least one conductive layer. For example, when the via 320 is formed by electroplating, the via 320 may include a seed layer formed on an inner wall of a via hole penetrating through the support member 200 and an electroplating layer filling the via hole in which the seed layer is formed. The seed layer of the via 320 and a seed layer (a first conductive layer to be described below) for forming the first and second coil patterns 311 and 312 may be formed together in the same process and integrally formed with each other, or may be formed in different processes to have a boundary formed therebetween. The via 320 may include a conductive material, such as copper (Cu), aluminum (Al), silver (Ag), tin (Sn), gold (Au), nickel (Ni), lead (Pb), titanium (Ti), chromium (Cr), molybdenum (Mo), or an alloy thereof.

First and second lead-out patterns 311e and 312e of the first and second coil patterns 311 and 312 may be connected to the first and second external electrodes 400 and 500, respectively. For example, the first lead-out pattern 311e of the first coil pattern 311 may be exposed to the first surface 101 of the body 100 and contact and be connected to the first external electrode 400. For example, the second lead-out pattern 312e of the second coil pattern 312 may be exposed to the second surface 102 of the body 100 and contact and be connected to the second external electrode 500.

The external electrodes 400 and 500 may have a monolayer or multilayer structure. For example, the first external electrode 400 may include a first layer including copper (Cu), a second layer disposed on the first layer and including nickel (Ni), and a third layer disposed on the second layer and including tin (Sn). Here, each of the first to third layers may be formed by plating, but is not limited thereto. As another example, the first external electrode 400 may include a resin electrode including conductive powder particles, such as silver (Ag), and a resin and a nickel (Ni)/tin (Sn) plating layer plated on the resin electrode. The external electrodes 400 and 500 may be formed of a conductive material, such as copper (Cu), aluminum (Al), silver (Ag), tin (Sn), gold (Au), nickel (Ni), lead (Pb), titanium (Ti), or alloys thereof, but is not limited thereto.

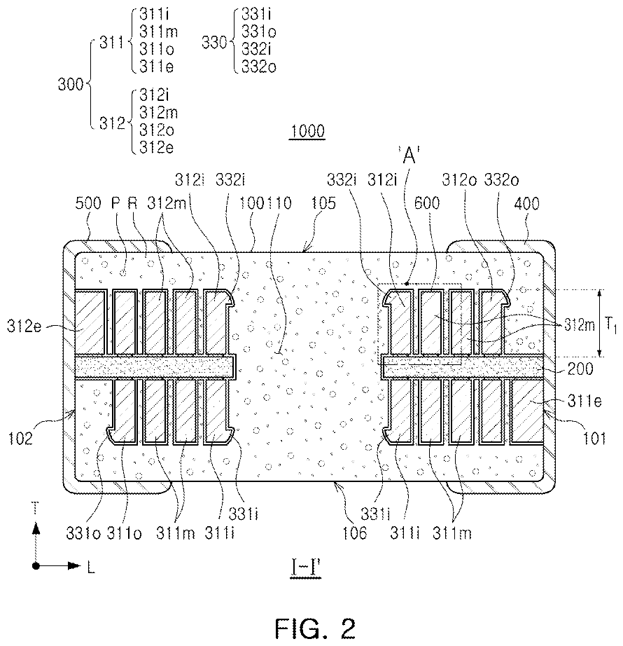

The first and second coil patterns 311 and 312 each have a planar spiral shape in which at least one turn is formed around the core 110 as an axis. For example, the first coil pattern 311 may form at least one turn with the core 110 as an axis on the lower surface of the support member 200 based on the direction of FIG. 2.

Referring to FIGS. 1 to 3, the coil component 1000 according to an exemplary embodiment may include a protrusion 330. The protrusion 330 may include at least one of a protrusion 331i located at the innermost turn 311i of the first coil pattern 311, a protrusion 331o located at the outermost turn 311o of the first coil pattern 311, a protrusion 332i located at the innermost turn 312i of the second coil pattern 312, and a protrusion 332o located at the outermost turn 312o of the second coil pattern 312.

The protrusions 331i and 332i may protrude from the innermost turns 311i and 312i in a direction away from the outermost turns 311o and 312o (a direction facing the center of the body 100), and the protrusions 331o and 332o may protrude from the outermost turns 311o and 312o in a direction away from the innermost turns 311i and 312i (a direction facing the side surface of the body 100). Accordingly, at least one of the innermost turns 311i and 312i and the outermost turns 311o and 312o of the plurality of turns may include the protrusions 331i, 331o, 332i, and 332o protruding in a direction away from each other from the innermost turns 311i and 312i and the outermost turns 311o and 312o.

A space between the innermost turns 311i and 312i and intermediate turns 311m and 312m or a space between the outermost turns 311o and 312o and the intermediate turns 311m and 312m may be a factor limiting a length of the protrusions 331i, 331o, 332i, and 332o protruding in a direction in which the innermost turns 311i and 312i and the outermost turns 311o and 312o face each other. However, directions in which the protrusions 331i, 331o, 332i, and 332o are away from each other from the innermost turns 311i and 312i and the outermost turns 311o and 312o may not impose restrictions on the protrusions 331i, 331o, 332i and 332o according to the space. Accordingly, the protrusions 331i, 331o, 332i, and 332o may further protrude in directions in which the protrusions 331i, 331o, 332i, and 332o are away from each other from the innermost turns 311i and 312i and the outermost turns 311o and 312o.

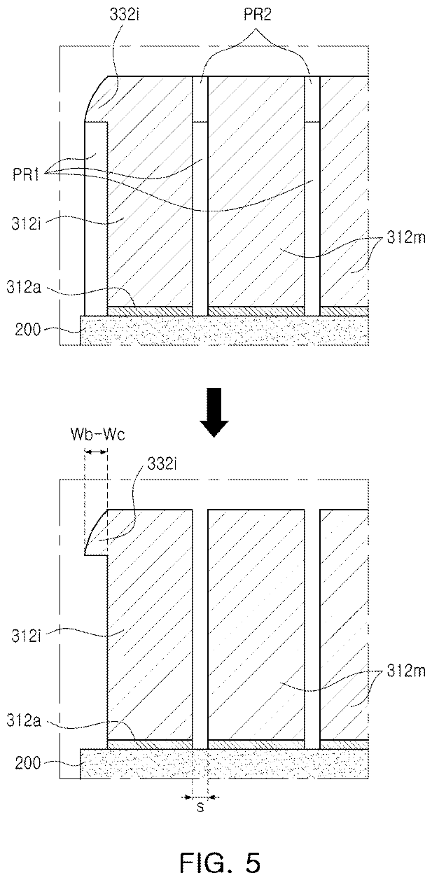

Referring to FIG. 5, according to a photolithography process, a plating resist PR1 may be first formed on the upper surface and/or the lower surface of the support member 200 prior to the innermost turns 311i and 312i, the intermediate turns 311m and 312m, and the outermost turn, and then a portion of each of the innermost turns 311i and 312i, the intermediate turns 311m and 312m, and the outermost turn may be formed. Considering an electrical short between the innermost turns 311i and 312i, the intermediate turns 311m and 312m, and the outermost turn, a thickness of the portion of the innermost turns 311i and 312i, the intermediate turns 311m and 312m, and the outermost turn formed on the side of the plating resist PR1 may not exceed a thickness of the plating resist PR1.

The plating resists PR1 and PR2 may be formed by applying liquid photosensitive materials or stacking sheet-type photosensitive materials. A width of the opening of the plating resists PR1 and PR2 (or a separation distance between adjacent insulating walls) corresponds to the width of the first and second coil patterns, and a width of an insulating wall corresponds to a separation distance between the turns of the first and second coil patterns described above. The thickness of the insulating wall corresponds to the heights of the first and second coil patterns described above. The plating resists PR1 and PR2 include a photoimageable dielectric (PID) that may be stripped by a stripping solution. For example, the plating resists RP1 and PR2 may include a photosensitive material including a cyclic ketone compound and an ether compound having a hydroxyl group as main components, and in this case, the cyclic ketone compound may be, for example, cyclopentanone, and the ether compound having a hydroxyl group may be, for example, poly propylene glycol monomethyl ether and the like. Alternatively, the plating resists PR1 and PR2 may include a photosensitive material including a bisphenol-based epoxy resin as a main component. In this case, the bisphenol-based epoxy resin may be, for example, bisphenol A novolak epoxy resin, bisphenol A diglycidyl ether bisphenol A polymer resin or the like. However, the scope of the present disclosure is not limited thereto, and any of the plating resists PR1 and PR2 may be applied as long as they may be stripped by a stripping solution. Since the thickness/width ratio of one layer of the plating resist PR1 may be limited, a thickness/width ratio of each portion of the innermost turns 311i and 312i, the intermediate turns 311m and 312m, and the outermost turn formed on the side of the plating resist PR1 may also be limited.

Thereafter, the plating resist PR2 is formed only in a portion between the innermost turns 311i and 312i and the intermediate turns 311m and 312m and a portion between the intermediate turns 311m and 312m and the outermost turn of the plating resist PR1, and the rest of each of the innermost turns 311i and 312i, the intermediate turns 311m and 312m, and the outermost turns may be formed. Accordingly, the aspect ratio, i.e., the thickness/width ratio of the innermost turns 311i and 312i, the intermediate turns 311m and 312m, and the outermost turn, may increase, and the protrusion 332i may also be formed.

Unlike in FIG. 5, the plating resist PR2 may be omitted according to design.

For example, the innermost turns 311i and 312i, the intermediate turns 311m and 312m, and the outermost turn may be formed by anisotropic plating competitive growth. Depending on the characteristics of the anisotropic plating competitive growth, the space between the innermost turns 311i and 312i, the intermediate turns 311m and 312m, and the outermost turn may be maintained even without the plating resist PR2. At this time, the protrusion 332i may also be formed.

For example, plating may be performed on the entirety of the plating resist PR1, the innermost turns 311i and 312i, the intermediate turns 311m and 312m, and the outermost turn without the plating resist PR2, and in the structure according to the plating, a portion overlapping the plating resist PR1 in a vertical direction may be removed by a photolithography and etching process. At this time, the protrusion 332i may also be formed.

After the protrusion 332i is formed, the plating resists PR1 and PR2 may be removed by an etching process. The etching process may be a method of locally irradiating a laser or a chemical method of selectively etching a specific material using an etching solution, but is not limited thereto.

Since the plating resists PR1 and PR2 are removed, a portion of the body 100 may be disposed in a space between the protrusion 332i and the support member 200, and the protrusion 332i may completely overlap the support member 200 in a direction (e.g., a vertical direction) in which the first and second coil patterns face each other, and the protrusion 332i may not be exposed to the outer surface of the body 100, but is not limited thereto.

Referring back to FIGS. 1 to 4, the protrusions 331i, 331o, 332i, and 332o may be formed by efficiently adjusting the aspect ratio (A/R), which is the thickness/width ratio of the first and second coil patterns 311 and 312, and thus, the coil component 1000 according to an exemplary embodiment in the present disclosure may efficiently increase the aspect ratio, efficiently obtain larger inductance or reduce energy loss based on the high aspect ratio.

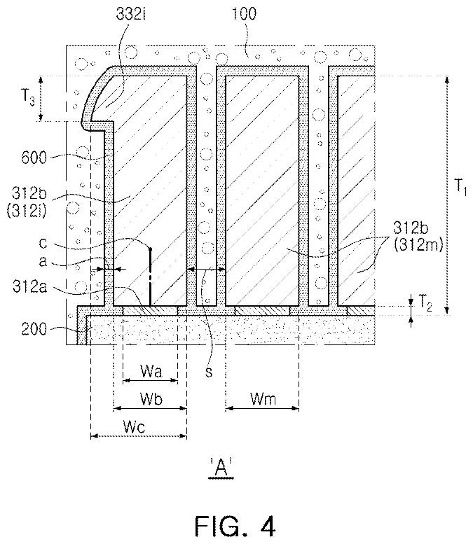

For example, due to the space s between the innermost turns 311i and 312i and the intermediate turns 311m and 312m or the space between the outermost turns 311o and 312o and the intermediate turns 311m and 312m, in at least one of the innermost turns 311i and 312i and the outermost turns 311o and 312o, a width difference (Wc−Wb in FIG. 4) between the portion in which the protrusions 331i, 331o, 332i, and 332o are located and the remaining portion may be greater than a difference (e.g., 0) between the maximum width (Wm of FIG. 4) of the intermediate turns 311m and 312m and the minimum width (Wm of FIG. 4) of the intermediate turns 311m and 312m between the innermost turns 311i and 312i and the outermost turn.

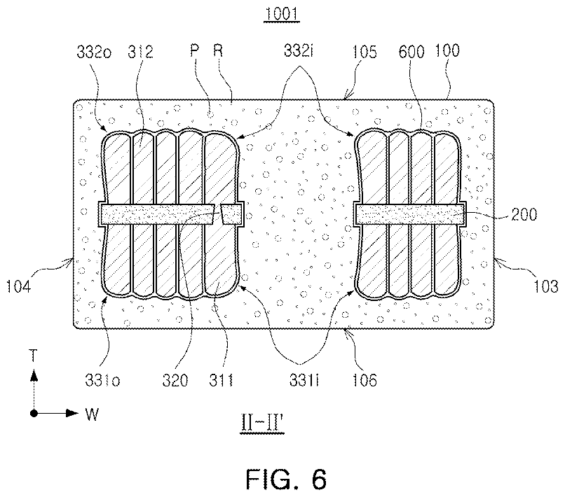

Alternatively, referring to FIGS. 5 and 6, protruding lengths (a value obtained by subtracting Wb from Wc in FIG. 4) of the protrusions 331i, 331o, 332i, and 332o may be longer than a separation distance (corresponding to s of FIG. 4) between the plurality of turns. For example, the protruding length (the value obtained by subtracting Wb from Wc in FIG. 4) of the protrusions 331i, 331o, 332i, and 332o may be 10 μm or more, and the separation distance (corresponding to s in FIG. 4) between the plurality of turns may be about 8 μm.

The insulating film 600 may serve to insulate the first and second coil patterns 311 and 312 from the body 100 and may include a known insulating material, such as parylene. Any insulating material may be included in the insulating film 600, and there is no particular limitation. The insulating film 600 may be formed by a method, such as vapor deposition, but is not limited thereto, and may be formed by laminating insulating films on both sides of the support member 200. In the former case (refer to FIGS. 2 to 4), the insulating film 600 may be formed in the form of a conformal film along the surfaces of the support member 200 and the first and second coil patterns 311 and 312. In the latter case (refer to FIGS. 5 and 6), the insulating film 600 may be formed to fill spaces between adjacent turns of the first and second coil patterns 311 and 312. Therefore, the thickness (a) of the insulating film 600 is not particularly limited either. Meanwhile, in the present disclosure, the insulating film 600 may be an optional component, and thus, if the body 100 secures sufficient insulation resistance under the operating conditions of the coil component according to the present exemplary embodiment, the insulating film 600 may be omitted.

Referring to FIGS. 2 and 4, the second coil pattern 312 may include a first conductive layer 312a disposed to contact one surface of the support member 200 and a second conductive layer 312b spaced apart from one surface of the support member 200 and disposed on the first conductive layer 312a, and the second conductive layer 312b may correspond to the innermost turn 312i, the intermediate turn 312m, and the outermost turn. Meanwhile, in the following, in order to avoid a redundant description, the first conductive layer and the second conductive layer will be described based on the second coil pattern 312, but this description will be applied to the first coil pattern 311 as it is.

The first conductive layer 312a may be formed from a seed layer for forming the second conductive layer 312b by electroplating. The seed layer may be formed by performing electroless plating or sputtering on the support member 200. When the seed layer is formed by sputtering or the like, at least a portion of the material constituting the first conductive layer 312a may penetrate into the support member 200. This may be confirmed by the fact that a concentration of the metal material constituting the first conductive layer 312a in the support member 200 varies in the thickness direction T of the body 100.

The first conductive layer 312a may include at least one of molybdenum (Mo), titanium (Ti), chromium (Cr), and copper (Cu). The first conductive layer 312a may have a multilayer structure, such as molybdenum (Mo)/titanium (Ti), but is not limited thereto.

The second conductive layer 312b may be formed by forming a plating resist having an opening in the seed layer and then filling the opening of the plating resist with a conductive material through electroplating. The second conductive layer 312b may include copper (Cu). For example, the second conductive layer 312b may be formed of copper (Cu) through electrolytic copper plating, but the scope of the present disclosure is not limited thereto. The first and second conductive layers 312a and 312b may include different metal materials. The second conductive layer 312b may be formed of a single layer through a single electroplating process or a plurality of layers through a plurality of electroplating processes.

The sum of the shortest thickness (distance) (T₁−T₂−T₃) from one surface of the second conductive layer 312b facing the first conductive layer 312a to the protrusion 332i and the thickness T₃ of the protrusion 332i (T₁−T₂) may exceed twice the width Wb of the portion of the second conductive layer 312b in which the protrusion 332i is not located. ((T₁−T₂)/Wb) may be defined as an aspect ratio of the second conductive layer 312b and may also be defined as an aspect ratio of the innermost turn 312i, the intermediate turn 312m, and the outermost turn.

The second conductive layer 312b may have the protrusion 332i so that the width Wc of a portion of the second conductive layer 312b is wider than the width Wb of one surface of the second conductive layer 312b facing the first conductive layer 312a, and the shortest thickness (distance) (T₁−T₂−T₃) from one surface of the second conductive layer 312b facing the first conductive layer 312a to the protrusion 332i may be greater than the thickness T₃ of the protrusion 332i. This is because the protrusion 332i may be formed in a process of efficiently increasing the aspect ratio of the second conductive layer 312b. The second conductive layer 312b may correspond to the innermost turn 312i, intermediate turn 312m, and outermost turn described above. Since the thickness T₂ of the first conductive layer 312a may be much thinner than T₁, the shortest thickness (distance) (T₁−T₃) from one surface of the coil unit facing the support member 200 to the protrusion 332i may be greater than the thickness T₃.

When further optimized, the thickness T₃ of the protrusion 332i may exceed 10% and less than 30% of the shortest thickness (distance) (T₁−T₂−T₃) from one surface of the second conductive layer 312b facing the first conductive layer 312a to the protrusion 332i. Since the thickness T₂ of the first conductive layer 312a may be much thinner than T₁, the thickness T₃ of the protrusion 332i may exceed 10% and less than 30% of the shortest thickness (distance) T₁−T₃ from one surface of the coil unit facing the support member 200 to the protrusion 332i.

As a result of manufacturing the coil component excluding the protrusion 332i, the thickness (T₁−T₂−T₃) was about 320 μm, the width Wb was about 132 μm, the thickness (T₁−T₂−T₃) was about 2.42 times the width Wb, inductance of the coil component was 0.435 μH, an equivalent series resistance of the coil component was 10.50 m ohm, and a saturation current was 10.39 A.

When manufacturing the coil component 1000 including the protrusion 332i, the thickness T₃ of the protrusion 332i was 50 μm, the thickness (T₁−T₂) was about 370 μm, the thickness (T₁−T₂) was about 2.8 times the width Wb, an inductance of the coil component 1000 was 0.443 μH, an equivalent series resistance of the coil component 1000 was 8.20 m ohms, and a saturation current was 10.60 A.

Therefore, the coil component 1000 according to an exemplary embodiment in the present disclosure may obtain a higher aspect ratio (e.g., 2.8), may obtain a larger inductance, may further reduce the equivalent series resistance, and may further increase the saturation current.

Meanwhile, referring to FIG. 4, based on a cross-section, perpendicular to one surface of the support member 200, one side surface of the first conductive layer 312a may be disposed to be closer to the center C of the second conductive layer 312b in the width direction than one side surface of the second conductive layer 312b. Specifically, since a distance from one side surface of the second conductive layer 312b to one side surface of the first conductive layer 312a exceeds 0, one side surface of the first conductive layer 312a may be disposed to be closer to the center C of the second conductive layer 312b in the width direction than one side surface of the second conductive layer 312b. As a result, the width Wa of the first conductive layer 312a may be smaller than the width Wb of the second conductive layer 312b. Meanwhile, the other side surface of the first conductive layer 312a facing one side surface of the first conductive layer 312a may be disposed to be closer to the center C of the second conductive layer 312b in the width direction than the other side surface of the second conductive layer 312b. The first conductive layer 312a may be formed by forming the second conductive layer 312b on the seed layer, chemically removing the plating resist using a stripping solution, and selectively removing the seed layer using a seed etchant. The seed etchant may react with the seed layer and may not react with the electroplating layer that is the second conductive layer 312b. As a result, the first conductive layer 312a, which is formed by selectively removing the seed layer, may have one side surface disposed on an inner side than the one side surface of the second conductive layer 312b.

Referring to FIG. 5, there may be no difference in width between the upper surface of the first conductive layer 312a and the lower surface of the second conductive layer 312b depending on the design. For example, this structure may be implemented by locally irradiating a laser.

Referring to FIG. 6, the shape of the protrusions 331i, 331o, 332i, and 332o of the coil component 1001 according to an exemplary embodiment in the present disclosure may be more curved than a shape (e.g., with a step) of the protrusions 331i, 331o, 332i, and 332o of FIGS. 1 to 5.

Meanwhile, T₁, T₂, T₃, Wa, Wb, Wc, Wm, a, c, and s in the present specification may be measured as average values of sizes of corresponding portions in the WT cross-section (or the LT cross-section) of coil component formed by grinding the coil component in the L direction (or W direction). For example, the WT cross-section and the LT cross-section may be applied to analysis using at least one of a transmission electron microscopy (TEM), an atomic force microscope (AFM), a scanning electron microscope (SEM), an optical microscope, and a surface profiler, and the sizes may be measured by visual inspection or image processing (e.g., pixel identification based on color or brightness of pixels, pixel value filtering for pixel identification efficiency, distance integration between identified pixels, etc.). Other methods and/or tools appreciated by one of ordinary skill in the art, even if not described in the present disclosure, may also be used.

The coil component according to an exemplary embodiment in the present disclosure may have an increased aspect ratio (A/R), which is a thickness/width ratio of a coil pattern, efficiently increased inductance to be advantageous to a greater thickness, and/or efficiently decreased energy loss.

While example exemplary embodiments have been illustrated and described above, it will be apparent to those skilled in the art that modifications and variations could be made without departing from the scope of the present disclosure as defined by the appended claims.

What is claimed is:

1. A coil component comprising:
a support member;
a coil unit disposed on at least one of one surface and the other surface of the support member and including at least one of first and second coil patterns respectively including a plurality of turns; and
a body in which the support member and the coil unit are embedded,
wherein at least one of an innermost turn and an outermost turn of the plurality of turns has a protrusion that protrudes in a direction toward a center of the body and toward a side surface of the body, respectively.

2. The coil component according to claim 1, wherein in the at least one of the innermost turn and the outermost turn, a difference in width between a portion in which the protrusion is located and a remaining portion is greater than a difference between a maximum width and a minimum width of an intermediate turn.

3. The coil component according to claim 1, wherein a protruding length of the protrusion is greater than a separation distance between the plurality of turns.

4. The coil component according to claim 1, wherein the protrusion is located in each of the innermost turn and the outermost turn, and
the protrusion is not exposed to an outer surface of the body.

5. The coil component according to claim 4, wherein
a protruding length of the protrusion located at the innermost turn is greater than a separation distance between the plurality of turns,
a protruding length of the protrusion located at the outermost turn is greater than the separation distance between the plurality of turns,
a difference in width between a portion in which the protrusion is located and a remaining portion of the innermost turn is greater than a difference between a maximum width and a minimum width of an intermediate turn between the innermost turn and the outermost turn, and
a difference in width between a portion in which the protrusion is located and a remaining portion of the outermost turn is greater than a difference between a maximum width and a minimum width of an intermediate turn between the innermost turn and the outermost turn.

6. The coil component according to claim 5, wherein
the coil unit includes the first and second coil patterns,
each of the first and second coil patterns includes a second conductive layer and a first conductive layer contacting and disposed between the second conductive layer and the support member,
the first and second conductive layers include different metal materials,
the protrusion is located in the second conductive layer of each of the innermost and outermost turns of the plurality of turns, and
a shortest distance from one surface of the second conductive layer facing the first conductive layer to the protrusion is greater than a thickness of the protrusion.

7. The coil component according to claim 1, wherein the coil unit includes the first and second coil patterns respectively disposed on one surface and the other surface of the support member,
the body includes a core penetrating through the first and second coil patterns and the support member, and
the protrusion completely overlaps the support member in a direction in which the first and second coil patterns face each other.

8. The coil component according to claim 1, further comprising
an insulating film surrounding the coil unit and disposed between the coil unit and the body, and
a portion of the body is disposed in a space between the protrusion and the support member.

9. The coil component according to claim 1, wherein a sum of a shortest distance from one surface of the coil unit facing the support member to the protrusion and a thickness of the protrusion exceeds twice a width of a portion of the coil unit in which the protrusion is not located, and
a shortest distance from the one surface of the coil unit facing the support member to the protrusion is greater than the thickness of the protrusion.

10. The coil component according to claim 9, wherein the thickness of the protrusion is greater than 10% and less than 30% of the shortest distance from the one surface of the coil unit facing the support member to the protrusion.

11. The coil component according to claim 1, wherein the innermost turn has only one protrusion, and the protrusion protrudes only toward the center of the body.

12. The coil component according to claim 1, wherein the outermost turn has only one protrusion, and the protrusion protrudes only toward the side surface of the body.

13. A coil component comprising:
a support member;
a coil unit disposed on at least one of one surface and the other surface of the support member and including at least one of first and second coil patterns; and
a body in which the support member and the coil unit are embedded,
wherein the at least one of the first and second coil patterns includes a second conductive layer and a first conductive layer contacting and disposed between the second conductive layer and the support member,
the second conductive layer has a portion including a protrusion protruding so that a width of the portion of the second conductive layer is wider than a width of one surface of the second conductive layer facing the first conductive layer, and
a shortest distance from the one surface of the second conductive layer facing the first conductive layer to the protrusion is greater than a thickness of the protrusion.

14. The coil component according to claim 13, wherein
the at least one of the first and second coil patterns has a plurality of turns,
the protrusion is located on at least one of innermost and outermost turns of the plurality of turns, and
in the at least one of the innermost turn and the outermost turn, a difference in width between a portion in which the protrusion is located and a remaining portion is greater than a difference between a maximum width and a minimum width of an intermediate turn between the innermost turn and the outermost turn.

15. The coil component according to claim 13, wherein the at least one of the first and second coil patterns has a plurality of turns, and a protruding length of the protrusion is greater than a separation distance between the plurality of turns.

16. The coil component according to claim 13, wherein the at least one of the first and second coil patterns has a plurality of turns,
the protrusion is located at each of innermost and outermost turns of the plurality of turns, and
the protrusion is not exposed to an outer surface of the body.

17. The coil component according to claim 13, wherein the coil unit includes the first and second coil patterns respectively disposed on one surface and the other surface of the support member,
the body includes a core penetrating through the first and second coil patterns and the support member, and
the protrusion completely overlaps the support member in a direction in which the first and second coil patterns face each other.

18. The coil component according to claim 13, further comprising:
an insulating film surrounding the coil unit and disposed between the coil unit and the body, and
a portion of the body is disposed in a space between the protrusion and the support member.

19. The coil component according to claim 13, wherein
a sum of a shortest distance from one surface of the coil unit facing the support member to the protrusion and a thickness of the protrusion exceeds twice a width of a portion of the second conductive layer in which the protrusion is not located, and
the thickness of the protrusion is greater than 10% and less than 30% of a shortest distance from one surface of the coil unit facing the support member to the protrusion.

20. The coil component according to claim 13, wherein, in a cross-section of the coil component perpendicular to the one surface of the support member, one side surface of the first conductive layer is disposed to be closer to a center of the second conductive layer in a width direction than one side surface of the second conductive layer.
